(19) United States
(12) Patent Application Publication
(10) Pub. No.: US 2010/0107105 A1
(43) Pub. Date: Apr. 29, 2010

(54) CONTROL APPARATUS, CONTROL SYSTEM OF ELECTRONIC DEVICE, AND METHOD FOR CONTROLLING ELECTRONIC DEVICE

(75) Inventor: Masaaki Kubo, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/605,505

(22) Filed: Oct. 26, 2009

(30) Foreign Application Priority Data
Oct. 28, 2008 (JP) 2008-276823

(51) Int. Cl. G06F 3/048

(52) U.S. Cl. 715/773

(57) ABSTRACT

An AV amplifier includes a selector which outputs a video signal input from an output device to a display device, a display controller which makes a display device display a virtual controller including a plurality of operation buttons and a cursor for selecting any operation button on the virtual controller together with a output video corresponding to an AV signal input form the output device, an operation signal receiver which receives an operation signal for moving the cursor on the virtual controller so as to select an operation button corresponding to a position of the cursor together with identification information for identifying a device to be controlled from an amplifier controller, and a control signal transmitter which transmits predetermined control signals set to the operation buttons for the AV devices to the device to be controlled according to the device to be controlled and the selected operation button.

### BACKGROUND OF THE INVENTION

1. Field of the Invention

The present invention relates to a control apparatus, a control system of an electronic device and a method for controlling the electronic device.

2. Description of the Related Art

In related art, AV (Audio Visual) devices which enable on-screen display output and have GUI (Graphical User Interface) function are known. In this kind of AV devices, a user uses a device controller to perform setting and operation on a GUI menu displayed on a display device connected to the device and checks the setting/operation states.

As described in Japanese Patent Application Laid-Open No. 10-116058, a control apparatus such as an AV amplifier which controls a plurality of AV devices is known. In this kind of control apparatus, a user uses a controller for the control apparatus to select an output device which outputs an AV signal to the control apparatus. The user checks the device being controlled by means of LED display on the controller, and transmits an operation signal for controlling the device from the controller to the control apparatus. The control apparatus stores control signals for controlling devices corresponding to operation signals in advance, and when receiving an operation signal from the controller, it transmits a control signal corresponding to the operation signal to a selected device.

The controller for the control apparatus is configured to transmit operation signals corresponding to various functions executable by a plurality of devices to the control apparatus. The use of the controller for the control apparatus allows the control apparatus to control the plurality of devices on a concentrated manner, so that operability of the devices can be improved.

### SUMMARY OF THE INVENTION

However, as the number of devices to be controlled increases and the number of various functions executable by the plurality of devices increase, the operation of the controller for the control apparatus becomes more complicated, thereby deteriorating the operability.

For example, when a complicated operation is performed by using the controller for the control apparatus, the operation should be performed while operation buttons of the controller are being checked, thereby deteriorating the operability. Particularly when the controller is operated in a dimly-lit place, it is difficult to check the operation buttons of the controller, thereby noticeably deteriorating the operability. When a device to be controlled is selected from a lot of connected devices so as to be controlled, an operation signal corresponding to a function of a device different from the device desired by a user might be transmitted due to erroneous operation.

The present invention has been made in view of the above issues, and it is desirable to provide new and improve control apparatus, control system of electronic devices, and method for controlling the electronic devices which improve operability of a controller for the control apparatus to be used for controlling a plurality of electronic devices.

In order to solve the above-mentioned issue, according to a first embodiment of the present invention, there is provided a control apparatus including a connecting interface which connects a plurality of electronic devices including one or more output devices and one or more display devices, a selector section which outputs a video signal input from a target output device selected from the one or more output devices to a target display device selected from the one or more display devices, a display control section which makes the target display device to display a virtual controller including a plurality of operation buttons and a cursor for selecting any operation button on the virtual controller as well as an output video to be displayed by the target display device correspondingly to the video signal input from the target output device, an operation signal receiving section which receives an operation signal for moving the cursor on the virtual controller so as to select the operation button corresponding to a position of the cursor as well as identification information for identifying a device to be controlled selected from the plurality of electronic devices from a controller for the control apparatus, and a control signal transmitting section which transmits predetermined control signals set to the operation buttons for the respective electronic devices to the device to be controlled according to the device to be controlled and the selected operation button.

According to such a constitution, an operation button is selected via an operation for moving the cursor on the virtual controller, and a predetermined control signal is transmitted to a device to be controlled according to the device to be controlled and the selected operation button. For this reason, the complicated operation of the controller for the control apparatus is resolved. Since the virtual controller as well as an output video from a target output device is displayed, an erroneous operation for transmitting operation signals corresponding to functions of devices other than the target output device is repressed. Further, while a change of the output video is being checked, the operation button can be selected on the virtual controller.

According to another embodiment of the present invention, there is provided a control system of electronic devices including the control apparatus according to the embodiment of the present invention. Further, according to another embodiment of the present invention, there is provided an electronic device controlling method which is applicable to the control apparatus according to the embodiment the present invention.

According to the present invention, there are provided the control apparatus, the control system of electronic devices and the method for controlling the electronic devices which are capable of improving operability of the controller for the control apparatus to be used for controlling the plurality of electronic devices.

### BRIEF DESCRIPTION OF THE DRAWINGS

FIG. 1 is a block diagram illustrating an outline of a control system according to one embodiment of the present invention;

FIG. 2 is a block diagram illustrating a constitution of an AV amplifier included in the control system shown in FIG. 1;

FIG. 3 is a front view illustrating one example of an amplifier controller;

FIG. 4A is a diagram illustrating one example of a virtual controller (main panel “menu”);

FIG. 4B is a diagram illustrating one example of a virtual controller (main panel “10 key”);

FIG. 4C is a diagram illustrating one example of a virtual controller (main panel “common device”);

FIG. 4D is a diagram illustrating one example of a virtual controller (sub-panel);

FIG. 5 is a diagram illustrating one example of a control table including control information about an AV device;

FIG. 6 is a flow chart illustrating a method for setting control information;

FIG. 7 is a diagram illustrating one example of a process selecting menu;

FIG. 8 is a diagram illustrating a setting menu of a setting process in a preset mode;

FIG. 9 is a diagram illustrating a setting menu of a setting process in a learning mode;

FIG. 10 is a diagram illustrating a setting menu of a process for setting macro information;

FIG. 11 is a diagram illustrating a constitutional example of the control system; and

FIG. 12 is a flow chart illustrating a method for operating the control system.

### DETAILED DESCRIPTION OF THE INVENTION

Hereinafter, preferred embodiments of the present invention will be described in detail with reference to the appended drawings. Note that, in the specification and the appended drawings, structural elements that have substantially the same function and structure are denoted with the same reference numerals, and repeated explanation of these structural elements is omitted.

Constitution of Control System 1

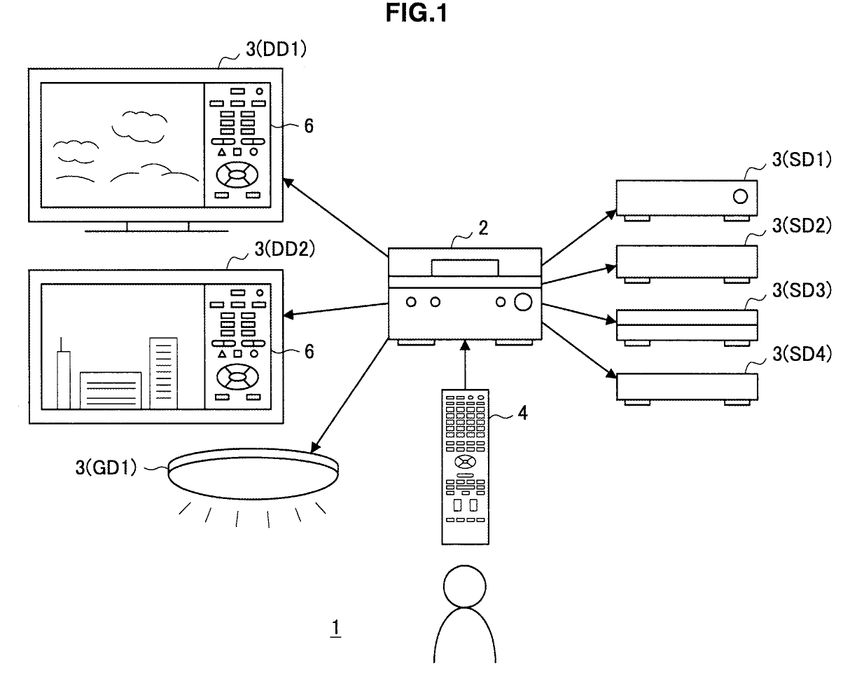

FIG. 1 is a block diagram illustrating an outline of a control system 1 according to one embodiment of the present invention. As shown in FIG. 1, the control system 1 has an AV amplifier 2 (control apparatus), AV devices 3 (electronic devices), and an amplifier controller 4 (controller for the control apparatus). Not shown in FIG. 1, but the AV devices 3 have related device controllers 5.

The AV devices 3 include an output device SD which outputs an AV (Audio Visual) signal to the AV amplifier 2 such as VTR, LD, DVD and BD (for example, SD1, SD2, SD3 and SD4). The output devices SD output AV signals including video/sound signals (or only a video signal), but may output only a sound signal. The AV devices 3 include common devices CD which are used together with the output devices SD, and the common devices CD include display devices DD (for example DD1 and DD2) such as a television and a projector, and a general device GD (for example, GD1) such as an illumination light.

The AV amplifier 2 is connected to one or more output devices SD and one or more display devices DD, and outputs AV signals input from the output devices SD to the display devices DD so as to display output videos corresponding to the AV signals. The AV amplifier 2 functions as a selector which selectively outputs an AV signal input from the output device SD selected by a user to the display device DD selected by the user. The AV amplifier 2 is connected also to the general device GD other than the display devices DD.

A user controls the AV devices 3 via the AV amplifier 2 using one or more amplifier controllers 4, so as to control the AV devices 3 by means of operations of the device controllers 5 corresponding to the AV devices 3, respectively. The user controls the AV amplifier 2 by means of the amplifier controller 4 using a virtual controller 6 displayed on the display device DD, so as to control the AV device 3 via the AV amplifier 2.

When the user uses the virtual controller 6, the AV amplifier 2 displays the virtual controller 6 as well as the output vide corresponding to the output device SD on the display device DD. The virtual controller 6 includes a plurality of operation buttons corresponding to the AV devices 3 to be controlled, and a cursor C for selecting any operation buttons on the virtual controller 6. The user moves the cursor C on the virtual controller 6 using the amplifier controller 4 so as to select a desired operation button instead of operating the device controller 5 of the AV device 3 to be controlled.

The AV amplifier 2 receives an operation signal according to the user's operation of the amplifier controller 4, and selects an operation button on the virtual controller 6 according to the operation signal. As to the AV amplifier 2, predetermined control signals for controlling the AV devices 3 are set to the operation buttons for the respective AV devices 3. When the user selects the operation button on the virtual controller 6, the AV amplifier 2 transmits a predetermined control signal corresponding to the AV device 3 to be controlled and the selected operation button to the AV device 3.

When the AV device 3 to be controlled receives the predetermined signal, it performs predetermined operation and process according to the control signal. As a result, the user operates the amplifier controller 4 so as to select the operation button on the virtual controller 6, so as to control the AV device 3 to be controlled via the AV amplifier 2.

Constitution of the AV Amplifier 2

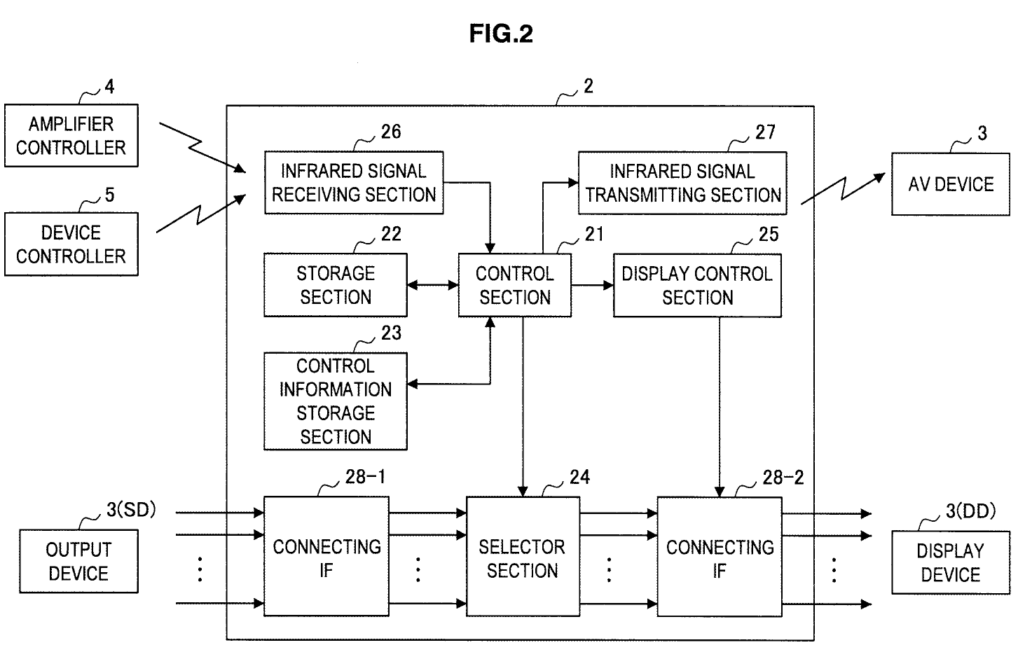

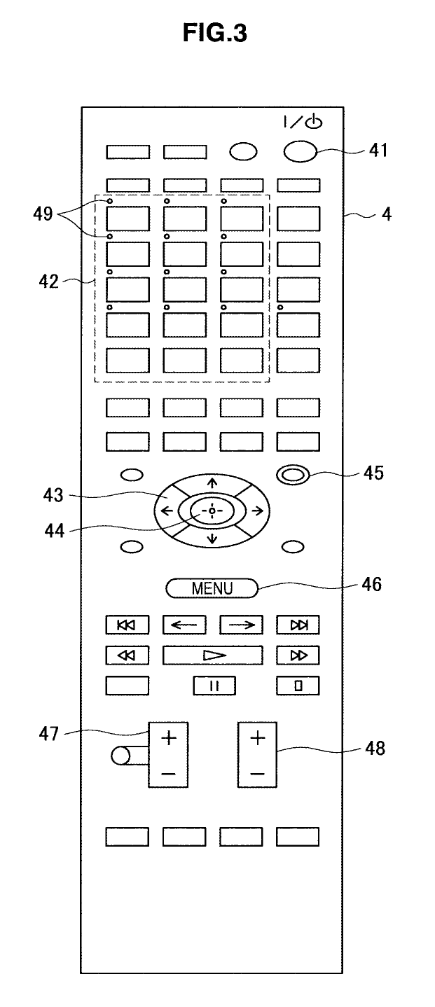

FIG. 2 is a block diagram illustrating a constitution of an AV amplifier 2 included in the control system 1 shown in FIG. 1. FIG. 3 is a front view illustrating one example of the amplifier controller 4.

The constitution of the AV amplifier 2 is described with reference to FIG. 2. As shown in FIG. 2, the AV amplifier 2 includes a control section 21, a storage section 22, a control information storage section 23, a selector section 24, a display control section 25, an infrared signal receiving section 26, an infrared signal transmitting section 27 and a connecting interface (IF) 28.

The control section 21 is configured with a microcomputer, and controls processes and the respective sections necessary for operating the AV amplifier 2. The control section 21 functions also as a control information setting section which executes a process for setting control information.

The storage section 22 is configured with a memory. The storage section 22 stores various data necessary for operating the AV amplifier 2, such as control signals transmitted from the AV amplifier 2 to the AV devices 3 therein according to operations of the operation buttons of the amplifier controller 4. The storage section 22 stores also image data about the virtual controller 6 and image data about setting menus therein.

The control information storage section 23 is configured with a memory. The control information storage section 23 stores predetermined control signals, which are set to the operation buttons on the virtual controllers 6 for the respective AV device 3, as control information therein. The predetermined control signal is transmitted to the AV device 3 to be controlled according to the AV device 3 to be controlled and the selected operation button.

The selector section 24 outputs an AV signal input from the output device SD specified by selector information to the display device DD specified by selector information via the connecting IF 28. The selector information is for specifying a combination of an output source and an output destination of AV signal, and is set by a user's operation of the AV amplifier 2 or the amplifier controller 4.

The display control section 25 is configured with a microcomputer. The display control section 25 generates a video signal for displaying an image of the virtual controller 6 or an image of the setting menu on the display device DD based on the data stored in the storage section 22, so as to output the images to the display device DD specified by selector information via the connecting IF 28.

The infrared signal receiving section 26 outputs an operation signal received from the amplifier controller 4 and a control signal received from the device controller 5 to the control section 21. The infrared signal transmitting section 27 transmits a predetermined control signal corresponding to the AV device 3 to the AV device 3 to be controlled under the control of the control section 21. The infrared signal receiving section 26 functions as an operation signal receiving section and a control signal receiving section, and the infrared signal transmitting section 27 functions as a control signal transmitting section.

The connecting IF 28 is an interface which connects the AV amplifier 2 and the AV device 3 in a wired and/or wireless manner. The connecting IF 28 includes an input connecting IF 28-1 which connects the output device SD, and an output connecting IF 28-2 which connects the display device DD. The connecting IF 28 inputs a video signal for displaying the image of the virtual controller 6 and the image of the setting menu on the display device DD from the display control section 25, and outputs the input video signal to the display device DD.

Amplifier Controller 4

The amplifier controller 4 is described below with reference to FIG. 3. The amplifier controller 4 includes a plurality of operation buttons which operate the AV amplifier 2 and the AV devices 3.

As shown in FIG. 3, the amplifier controller 4 includes a power button 41 for the AV amplifier 2, device selecting buttons 42, up, down, right and left buttons 43, a determination button 44, a virtual controller display button 45, a menu display button 46, a volume adjusting button 47, and a channel selecting button 48. Further, LED lamps 49, which display selected states of the AV devices 3 by means of the device selecting buttons 42, and the other setting states are provided.

A user controls the AV amplifier 2 according to the operation of the operation buttons of the amplifier controller 4 so as to control the AV devices 3 via the AV amplifier 2. When the user operates the operation button of the amplifier controller 4, the amplifier controller 4 transmits operation signals allocated to the respective operations buttons to the infrared signal receiving section 26.

When the control section 21 determines that the received operation signal is an operation signal for controlling the AV amplifier 2, it executes a process corresponding to the operation signal and/or outputs a control signal corresponding to the operation signal to the respective sections. Further, when the control section 21 determines that the received operation signal is an operation signal for controlling the AV device 3, it transmits a control signal corresponding to the operation signal from the infrared signal transmitting section 27 to the AV device 3 to be controlled.

As described below, the user selects an operation button on the virtual controller 6 by means of the operation of the up, down, right and left buttons 43 and the determination button 44 of the amplifier controller 4 so as to control the AV amplifier 2 and the AV devices 3.

Virtual Controller 6

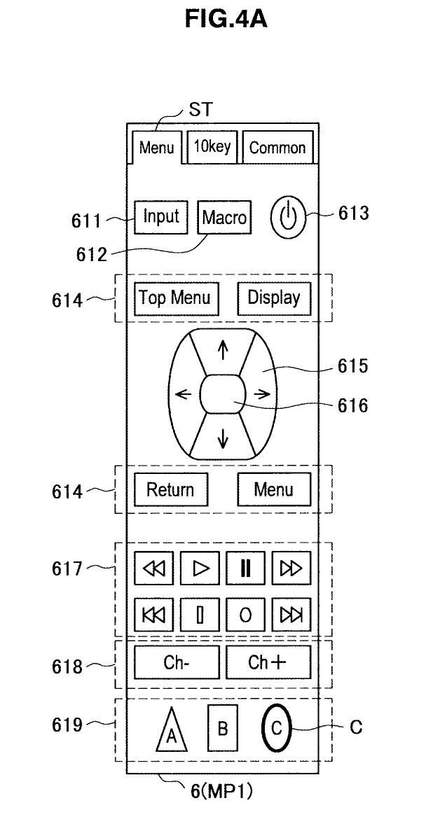

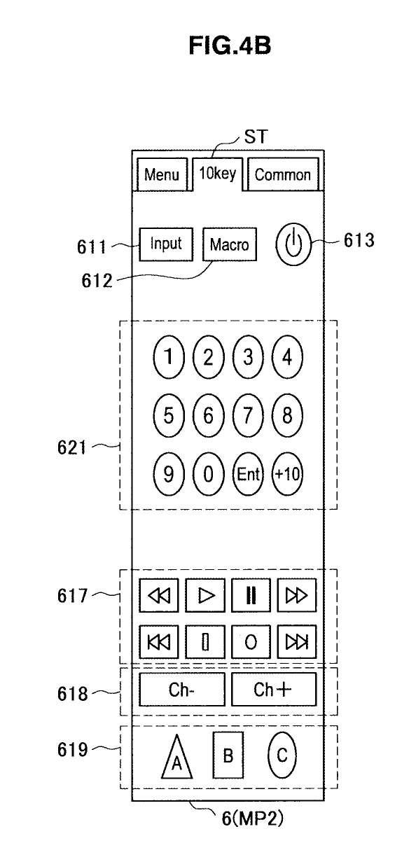

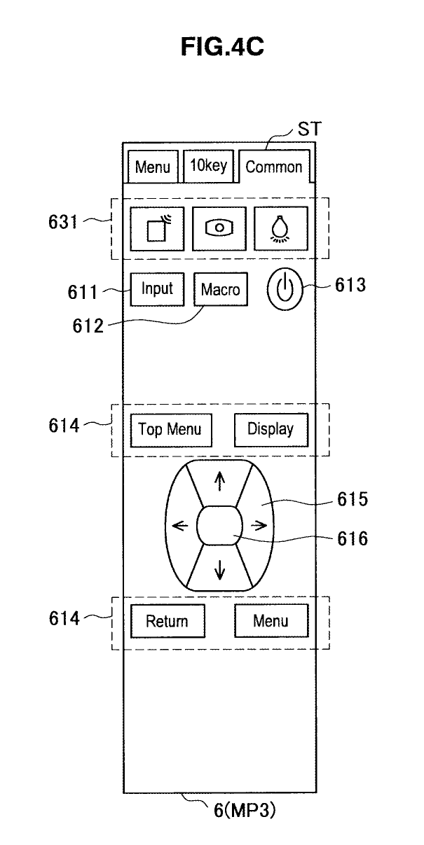

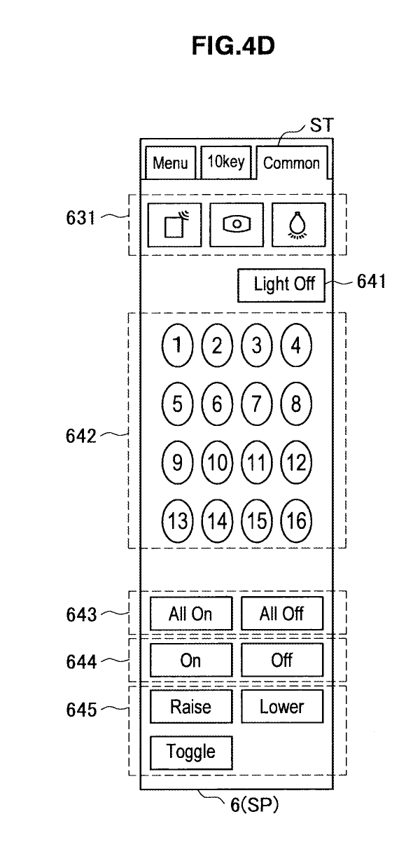

FIGS. 4A to 4D are diagrams illustrating examples of the virtual controller 6. The virtual controller 6 as well as an output video corresponding to an AV signal from the output device SD is displayed on the display device DD. The user can switch the virtual controller 6 between display/non-display on a screen of the display device DD by means of the operation of the virtual controller display button 45 of the amplifier controller 4.

As shown in FIGS. 4A to 4C, the virtual controller 6 includes three main panels “menu” MP1, “10 key” MP2 and “common device” MP3. The main panels “menu” MP1 and “10 key” MP2 are used for controlling the AV amplifier 2 and the output devices SD. The main panel “common device” MP3 is used for controlling the AV amplifier 2 and the common devices CD. The user selects a selecting tab ST provided onto the upper portion of the virtual controller 6 so as to switch the main panel among “menu (Menu)” MP1, “10 key” MP2 and “common device (Common)” MP3.

As shown in FIG. 4A, the main panel “menu” MP1 includes an input switching (Input) button 611, a macro (Macro) button 612, a power button 613 of the AV amplifier 2, menu related (Top Menu, Menu, Display, Return) buttons 614, up, down, right and left buttons 615 and a determination button 616.

The input switching button 611 is an operation button for switching the output device SD which inputs an AV signal into the AV amplifier 2. The user operates the input switching button 611, so as to switch output videos corresponding to the AV signals input from VTR, LD, DVD and BD and display the output video on the display device DD. The macro button 612 is an operation button for calling macro information, described later, so as to execute it. The power button 613 is an operation button for controlling the power of the AV amplifier 2. The menu related buttons 614 are operation buttons for switching display of setting/operation menu. The up, down, right and left buttons 615 and the determination button 616 are operation buttons for selecting/determining the setting/operation items on the setting/operation menu.

The main panel “menu” MP1 includes record/play related buttons 617 such as rewind, play fast-forward, record, pause, stop, forward, and backward buttons, channel selecting (Ch− and Ch+) buttons 618, and preset function (A, B and C) buttons 619.

The recording/play related buttons 617 are operation buttons for allowing the output device SD to execute a recording process and a reproducing process. The channel selecting buttons 618 are operation buttons for selecting a channel of a video signal to be input into the output device SD via an antenna. The preset function buttons 619 are operation buttons for executing preset functions which are preset.

As shown in FIG. 4B, the main panel “10 key” MP 2 includes the input switching button 611, the macro button 612, the power button 613 of the AV amplifier 2, number buttons 621 such as “0”, “1”, “2”, . . . , “9”, the record/play related buttons 617, the channel selecting buttons 618, and the preset function buttons 619. The number buttons 621 are operation buttons for inputting numerical values on the setting/operation menu.

As shown in FIG. 4C, the main panel “common device” MP3 includes common device selecting (TV, Projector, Light) buttons 631, the input switching button 611, the macro button 612, the power button 613 of the AV amplifier 2, the menu related buttons 614, the up, down, right and left buttons 615, and the determining button 616. The common device selecting buttons 631 are operation buttons for selecting a common device CD to be controlled.

The main panel “common device” MP3 includes a sub-panel SP according to the respective common devices CD (in the case of FIG. 4C, television projector and illumination light). FIG. 4D illustrates the sub-panel SP for television as one example. When a television is selected by the common device selecting button 631 on the main panel “common device” MP3, the sub-panel SP for television is displayed instead of the main panel MP3.

The sub-panel SP for television includes the common device selecting buttons 631, a light off (Light Off) button 641, and number buttons 642 such as “1”, “2”, “3”, . . . , “16”. The sub-panel SP for television includes power On/Off (All On, All Off) buttons 643 for all the common devices, power On/Off (On, Off) buttons 644 for the common devices, light adjusting (Raise, Lower, Toggle) buttons 645.

The light off button 641 is an operation button for turning off the illumination light as one of the common device CD. The number buttons 642 are operation buttons for inputting numerical values on the setting/operation menu, or selecting a channel of a video signal to be input into a television as one of the common device CD via the antenna. The power On/Off buttons 643 for all the common devices are operation buttons for controlling the powers of all the common devices CD simultaneously. The power On/Off buttons 644 for each common device are operation buttons for controlling a power of a common CD selected by the common device selecting button 631. The light adjusting buttons 645 are operation buttons for adjusting illumination light as one of the common device CD.

When the virtual controller 6 is used, a user operates the virtual controller display button 45 of the amplifier controller 4 so as to display the main panel “menu” MP1 on the screen of the display device DD. The user selects the selecting tab ST provided on the upper portion of the main panel MP according to the AV device 3 to be controlled, so as to select the main panel MP to be used for operating the AV device 3 to be controlled.

The user operates the up, down, right and left buttons 43 so as to move the cursor C to a desired operation button on the virtual controller 6 (main panel or sub-panel) (for example, in FIG. 4A, the cursor C is on the preset (C) button 619). The user operates the determination button 44 so as to select the operation button. When the user selects the operation button, the infrared signal receiving section 26 receives an operation signal including identification information about the AV device 3 to be controlled (in the embodiment, any one of the output device SD, the television, the projector and the illumination light) from the amplifier controller 4.

The control section 21 specifies the AV device 3 to be controlled based on the identification information included in the received operation signal and the selector information if necessary, and specifies a control signal corresponding to the selected operation button based on the control information about the AV device 3 stored in the control information storage section 23. The control section 21 transmits the specified control signal to the AV device 3 to be controlled from the infrared signal transmitting section 27.

When the virtual controller 6 is used, the user operates only the up, down, right and left buttons 43 and the determination button 44 on the amplifier controller 4, so as to control the AV amplifier 2 and the AV device 3. As a result, the operation button is selected through a moving operation of the cursor C on the virtual controller 6, and a predetermined control signal is transmitted to the AV device to be controlled by the selected operation button. For this reason, the complicated operation of the amplifier controller 4 is dissolved.

Method for Operating the Control System 1

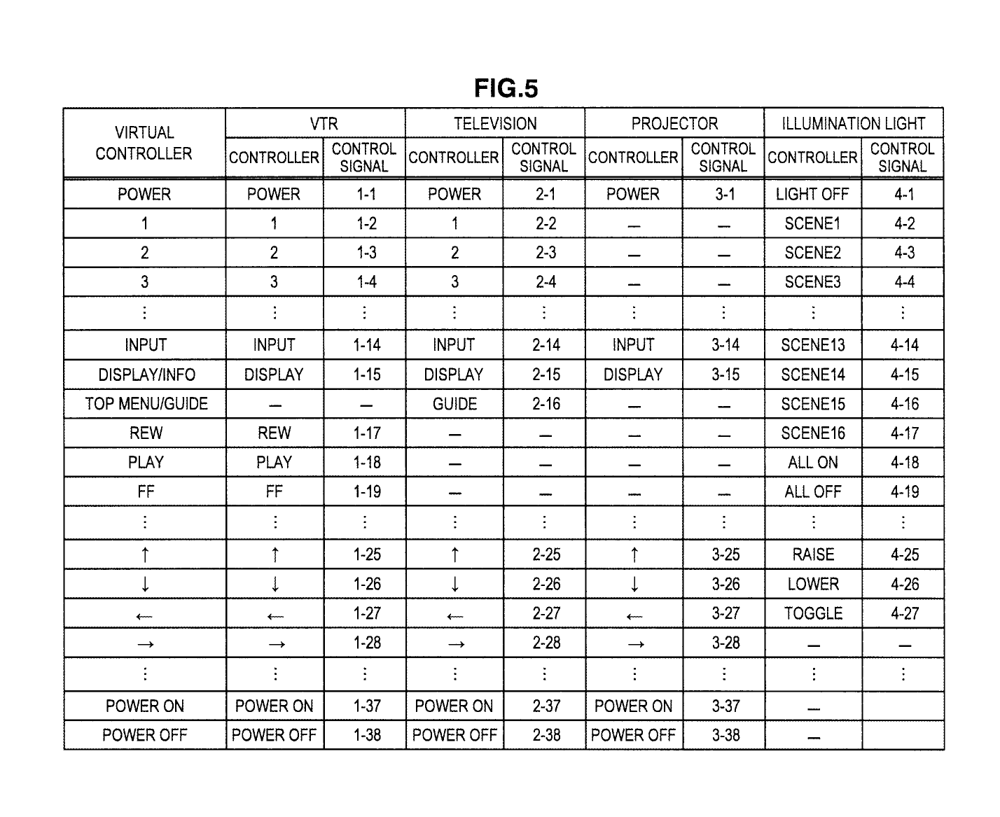

A method for controlling the electronic devices according to one embodiment of the present invention is described below with reference to FIGS. 5 to 12.

Method for Setting Control Information

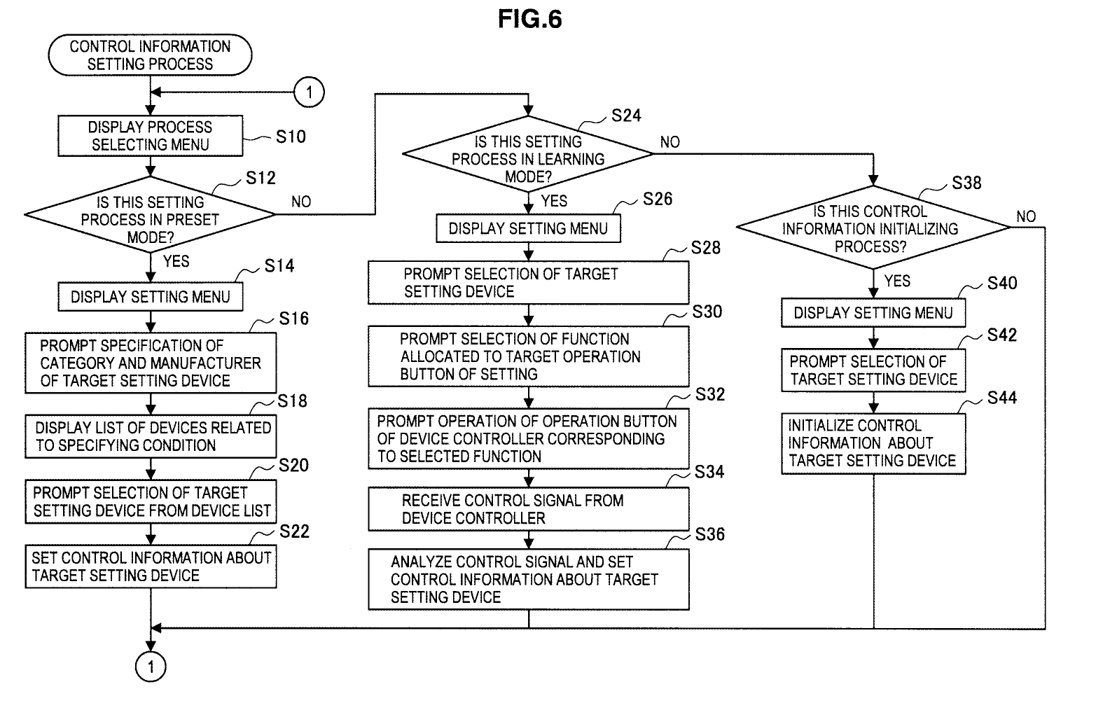

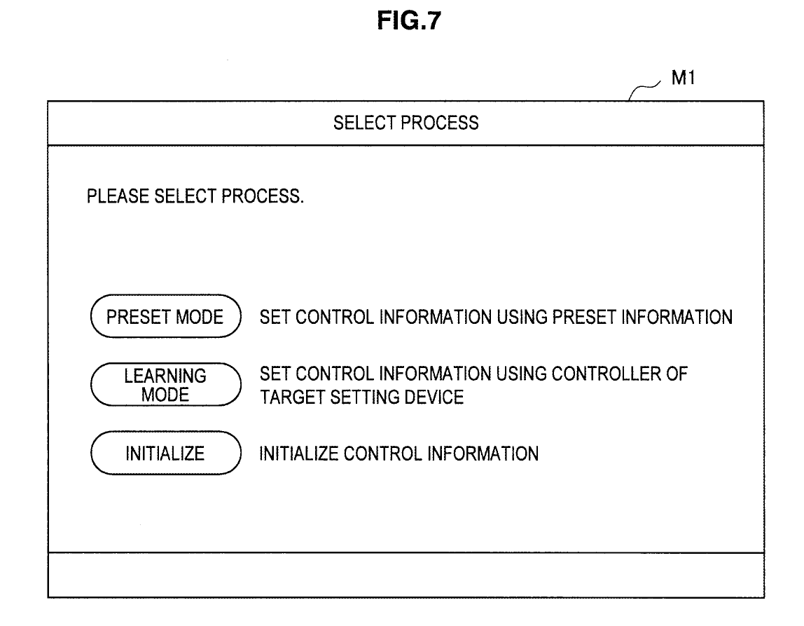

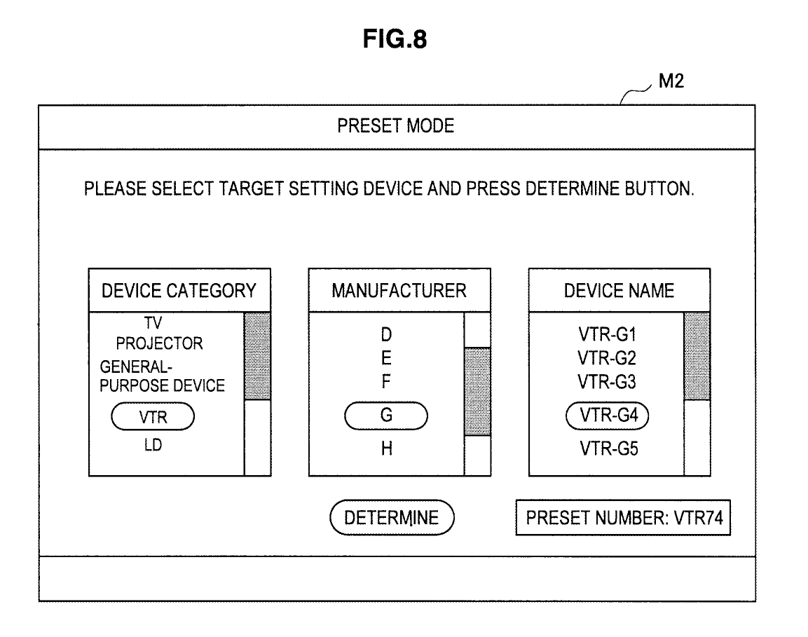

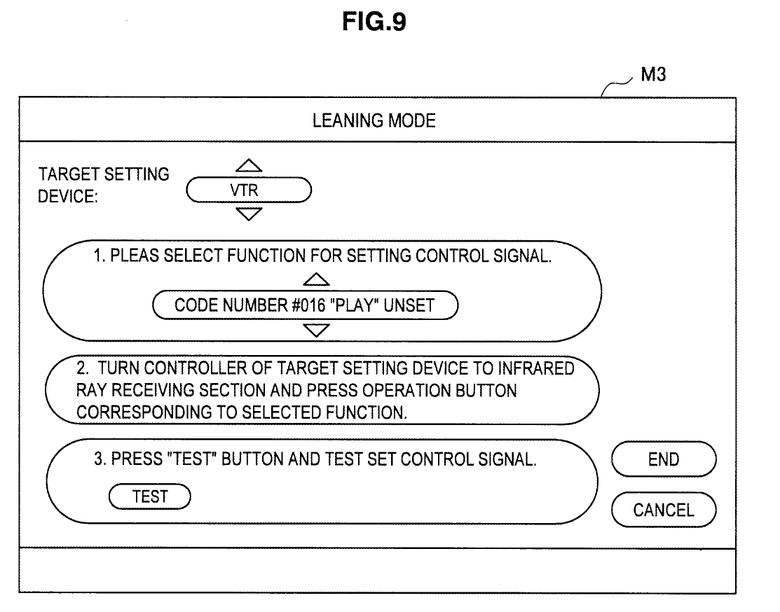

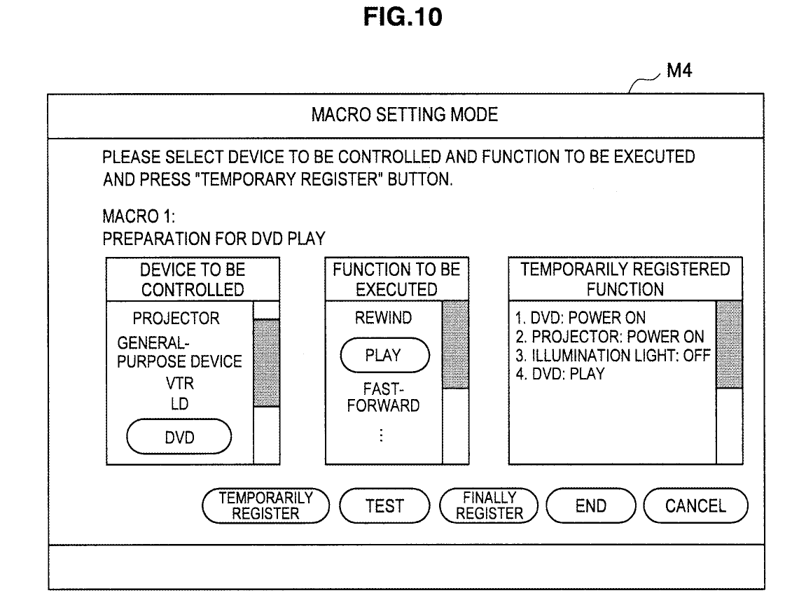

A method for setting control information is described with reference to FIGS. 5 to 9. FIG. 5 is a diagram illustrating one example of a control table including control information about the AV device 3. FIG. 6 is a flow chart illustrating a method for setting the control information. FIG. 7 is a diagram illustrating one example of a process selecting menu M1. FIG. 8 is a diagram illustrating a setting menu M2 of the setting process in a preset mode. FIG. 9 is a diagram illustrating a setting menu M3 of the setting process in a learning mode. FIG. 10 is a diagram illustrating a setting menu M4 of the setting process for macro information.

The AV amplifier 2 stores the control information about the AV devices 3 as the control table into the control information storage section 23. The control table is information for relating control signals for controlling the AV devices 3 to the identification information about the AV devices 3 and the operation buttons on the virtual controller 6.

FIG. 5 illustrates the control table for VTR, television, projector and illumination light. A row direction of the control table shows the operation buttons on the virtual controller 6 such as Power, 1, 2, 3, . . . , and Input, Display/Info.

A column direction of the control table shows the functions to be executed by the AV devices 3 selected to be controlled when the operation buttons on the virtual controller 6 are selected. Further, the column direction shows the control signals transmitted from the AV amplifier 2 according to the functions executed by the AV devices 3 (corresponding to the control signals transmitted from the device controllers 5 to the AV devices 3.

In the case of VTR, when the Input button and the Display/Info button are selected on the virtual controller 6, the control signals 1-14 and 1-15 are transmitted from the AV amplifier 2 to the VTR, and the VTR executes the Input and Display functions. When the Top Menu and Guide buttons are selected on the virtual controller 6, corresponding functions of VTR are not present, and thus the AV amplifier 2 does not transmit a control signal.

When the control information is set, a user selects a control information setting process on the top menu displayed on the display device DD. The control section 21 reads image data of the process selecting menu from the storage section 22, and displays the image data on the display device DD via the display control section 25 (step S10).

FIG. 7 illustrates one example of the process selecting menu M1. The user can select the setting process in the preset mode or the setting process in the learning mode or a setting value initializing process on the process selecting menu M1 shown in FIG. 7.

The Setting Process in the Preset Mode

In the setting process in the present mode, a user selects control information corresponding to a target setting device from the control information which is preset for the respective AV devices 3 so that the control signals are allocated to the operation buttons of the virtual controller 6 according to the AV devices 3. As a result, the control information about the target setting device can be set.

The control information about the AV devices 3 is classified according to categories and manufacturers of the AV devices 3 so as to be stored in the control information storage section 23. Preset numbers which can specify the AV devices 3 are allocated to the control information about the AV devices 3.

When the user selects the setting process in the preset mode on the process selecting menu M1 (S12), the control section 21 displays the setting menu M2 shown in FIG. 8 on the display device DD (S14). The control section 21 prompts the user to specify categories and manufacturers of the AV devices 3 (S16). When the user specifies categories and manufacturers of the AV devices 3, the control section 21 searches the AV devices 3 matched with the specified conditions so as to display them as a list on the display device DD (S18).

The control section 21 prompts the user to select the target setting device from the list of the AV devices 3 (S20). When the user selects the target setting device, the control section 21 sets a preset number corresponding to the selected AV device 3 as information for specifying control information about the target setting device (S22).

When the virtual controller 6 is used, the control section 21 specifies a control signal corresponding to the operation button selected on the virtual controller 6 according to the AV device 3 based on the control information corresponding to the preset number. The control section 21 transmits the specified control signal from the infrared signal transmitting section 27 to the AV device 3.

As a result, the user selects the control information about the target setting device from the control information preset for the respective AV device 3 using the setting menu M2 of GUI, so as to easily set the control information corresponding to the target setting device.

Setting Process in the Learning Mode

In the setting process in the learning mode, a user can set control information about a target setting device using the device controller 5 for the target setting device.

When the user selects the setting process in the learning mode on the process selecting menu (S24), the control section 21 displays the setting menu M3 shown in FIG. 9 on the display device DD (S26). The control section 21 prompts the user to select the target setting device (S28). When the user selects the target setting device, the control section 21 prompts the user to select a function allocated to the operation button for which the control information is set from the operation buttons on the virtual controller 6 corresponding to the target setting device (S30).

When the user selects the function, the control section 21 prompts the user to operate the operation button of the device controller 5 corresponding to the function selected on the setting menu M3 using the device controller 5 of the target setting device (S32). When the user selects the play function allocated to the play/record button (play) of the virtual controller 6, the user operates the operation button “play” of the device controller 5 for the target setting device corresponding to the function.

The control section 21 checks if the control signal is received from the device controller 5 for the target setting device for constant time after the function is selected on the setting menu M3. When the control signal is received within the constant time (S34), the control section 21 analyzes the received control signal, and sets the control information about the target setting device so that the control signal is allocated to the operation button of setting target (S36). On the other hand, when the control signal is not received within the constant time, the control section 21 interrupt the setting process.

The control section 21 may temporarily update the control information instead of setting the control information at step S36. In this case, after the control information is temporarily updated, the user operates a “test” button on the setting menu M3 so as to test a setting state of the control information.

When the user operates the “test” button, the control section 21 transmits the set control signal from the infrared signal transmitting section 27 to the target setting device. The user checks if the target setting device executes predetermined operation and process corresponding to the function allocated to the operation button for setting. When the user checks that the target setting device executes the predetermined operation and process, the user selects the control information updating process, and the control section 21 sets (updates) the control information and ends the setting process. In the other cases, the control section 21 returns the temporarily updated control information to the state before temporary updating, and continues or interrupts the setting process.

When the virtual controller 6 is used, the control section 21 specifies a control signal corresponding to the operation button selected on the virtual controller 6 according to the AV device 3 based on the updated control information. The control section 21 transmits the specified control signal from the infrared signal transmitting section 27 to the AV device 3.

As a result, the user transmits the control signal from the device controller 5 for the target setting device using the setting menu M3 of GUI, so as to easily set the control information corresponding to the target setting device.

The Setting Value Initializing Process

In the setting value initializing process, the user initializes control information about a target setting device.

When the user selects the setting value initializing process on the process selecting menu M1 (S38), the control section 21 displays the setting menu on the display device DD (S40) and prompts the user to select the target setting device (S42). When the user selects the target setting device, the control section 21 returns the control information set by the preset mode or the learning mode to a default value so as to initialize the control information in the target setting device selected by the user on the setting menu (S44).

Macro Information Setting Process

The user can set a plurality of control signals which are combined so that the AV amplifier 2 and the AV device 3 executes a series of operations and processes as macro information. When the user calls desired macro information by means of the operation of the macro button 612 on the virtual controller 6, the AV amplifier 2 and the AV device 3 can be controlled according to the plurality of control signals set as the macro information.

The user sets macro information according to the setting menu M4 shown in FIG. 10. The user selects a device to be controlled from the AV amplifier 2 or the AV devices 3 using the amplifier controller 4. The user selects a function which is executed by the device to be controlled from the functions executable by the device to be controlled. The control section 21 displays the selected device to be controlled and function on the setting menu M4 via the display control section 25, so as to temporarily register a related control signal as the macro information.

The user selects one or more devices to be controlled and one or more functions in the similar procedure. The control section 21 displays the selected devices to be controlled and functions on the setting menu M4 via the display control section 25 so as to temporarily register related control signals as the macro information.

FIG. 10 illustrates a case where macro information 1 for executing a series operations including power On of DVD, power On of a projector, power Off of illumination light and play of DVD is temporarily registered as preparation for DVD play. In this case, the macro information includes control signals corresponding to the DVD power-On function, the projector power-On function and the illumination light power-Off function and the DVD play function.

After the macro information is temporarily registered, the user operates the “test” button on the setting menu M4, so as to test the setting state of the macro information. When the user operates the “test” button, the control section 21 transmits the respective control signals from the infrared signal transmitting section 27 to the respective devices to be controlled according to the set macro information, or controls the respective sections of the AV amplifier 2 according to the control signals included in the macro information.

The user checks whether the devices to be controlled or the AV amplifier 2 execute the predetermined operations and processes corresponding to the macro information. When the user checks that the devices to be controlled or the AV amplifier 2 execute the series of operations and processes, the user selects the macro information registering process, and the control section 21 ends the setting process. In the other cases, the control section 21 returns the temporarily registered macro information to the state before temporary registration so as to continue or interrupt the setting process.

When the macro function is called and executed by using the virtual controller 6 and the user operates the macro button 612 of the controller 6, the control section 21 displays the registered macro information on a macro information selecting menu via the display control section 25. When the user selects desired macro information, the control section 21 transmits the control signals from the infrared signal control section 27 to the devices to be controlled according to the selected macro information.

As a result, the user selects one or more devices to be controlled and one or more functions on the setting menu M4 of GUI so as to easily set the macro information including the plurality of control signals.

The Method for Operating the Control System 1

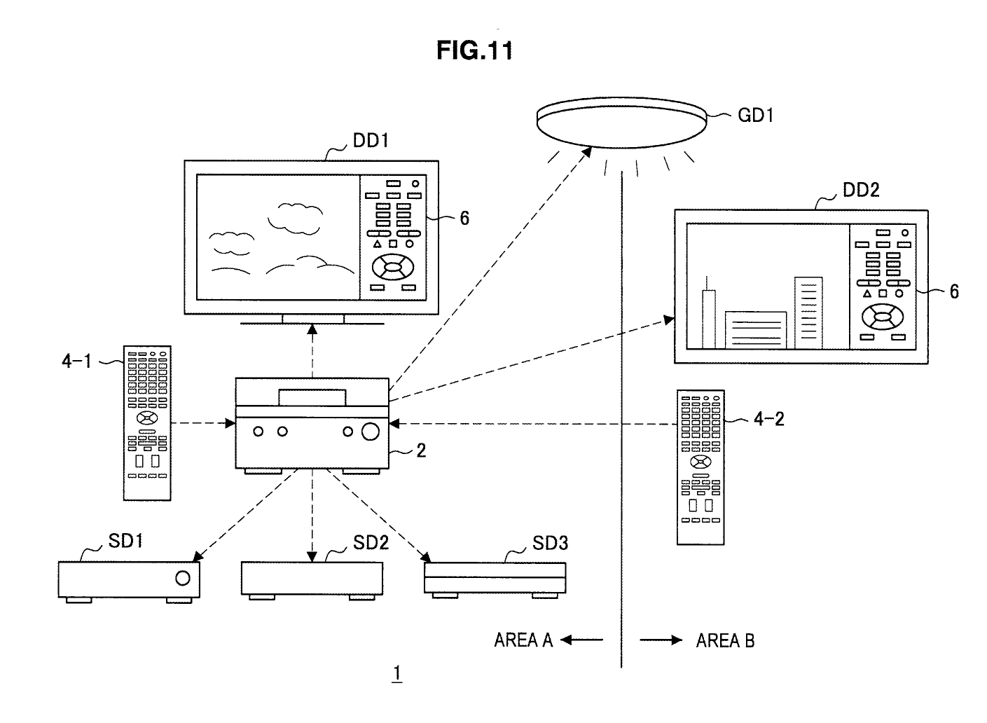

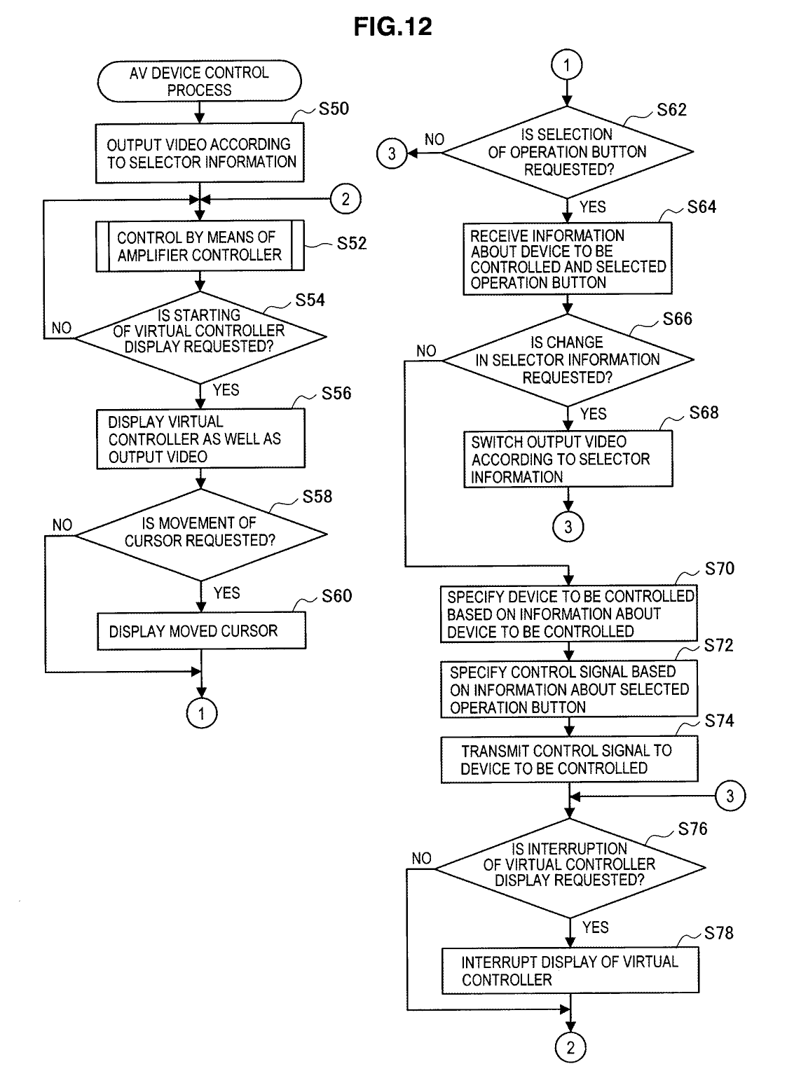

The method for operating the control system 1 according to one embodiment of the present invention is described with reference to FIGS. 11 and 12. FIG. 11 is a diagram illustrating a constitutional example of the control system 11. FIG. 12 is a flow chart illustrating the method for operating the control system 1.

As shown in FIG. 11, the control system 1 includes the AV amplifier 2, the output devices SD1, SD2 and SD3 and the display devices DD1 and DD2, and an illumination light GD1. The output devices SD1, SD2 and SD3 are, for example, VTR, LD and DVD, and the display devices DD1 and DD2 are, for example, a projector and a television. The AV amplifier 2 is connected to the output devices SD1, SD2 and SD3 and the display devices DD1 and DD2 via the connecting IF 28 in wired or wireless manner.

The control system 1 is installed in an installation space such as a conference hall, and the installation space is divided into a first area (for example, a device monitor room) and a second area (for example, a conference room). The AV amplifier 2, the output devices SD1, SD2 and SD3 and the display device DD1 are installed in the first area, and the display device DD2 is installed in the second area. The illumination light GD1 is commonly used in the first and second areas.

The control system 1 includes first and second amplifier controllers 4-1 and 4-2. The first amplifier controller 4-1 is used in the first area, and the second amplifier controller 4-2 is used in the second area. The first and second amplifier controllers 4-1 and 4-2 transmit an operation signal according to a user's operation to the AV amplifier 2. When the control system 1 includes the plurality of amplifier controllers 4, the respective amplifier controllers 4 transmit operation signals as well as identification information about the controllers.

The output devices SD1, SD2 and SD3 are set so as to output AV signals 1, 2 and 3 to the AV amplifier 2. Any one of the AV signals 1, 2 and 3 is input into the display devices DD1 and DD2 from the AV amplifier 2, and the display devices DD1 and DD2 display any one of related output videos 1, 2 and 3.

The control signals for controlling the output devices SD1, SD2, SD3, the display devices DD1 and DD2, and the illumination light GD1 are preset as default values by the process for setting the control information in the preset mode and the learning mode. The AV amplifier 2 receives the operation signals including the identification information about the AV device 3 to be controlled as well as the identification information about the amplifier controllers 4 according to selection of the operation button on the virtual controller 6. The AV amplifier 2 specifies a control signal corresponding to the operation button based on the control information about the AV device 3 to be controlled and the selector information if necessary, and transmits the specified control signal to the device.

The AV amplifier 2 allows a user to set selector information representing combinations of output sources and output destinations of the AV signals for the respective first and second amplifier controllers 4-1 and 4-2. In the following case, it is assumed that selector information 1 (output source: the output device SD1, the output destination: the display device DD1) and selector information 2 (output source: the output device SD2, the output destination: the display device DD2) are set. In this case, the AV amplifier 2 outputs an AV signal 1 to the display device DD1 and outputs an AV signal 2 to the display device DD2 based on the selector information 1 and 2 (S50).

The user operates the device selecting buttons 42 of the first or second amplifier 4-1 or 4-2 so as to change the setting of the selector information. When the user selects the output device SD3 using the first amplifier controller 4-1, the selector section 24 changes the output source specified by the selector information 1 from the output device SD1 into the output device SD3. The control section 21 displays an output video 3 to the display device DD1 instead of an output video 1 according toe the selector information 1.

The user operates the first or the second amplifier controllers 4-1 and 4-2 without using the virtual controller 6 so as to control the AV amplifier 2, the output devices SD (for example, SD1, SD2 and SD3), and the common devices CD (for example, DD1, DD2 and GD1) (S52).

When the user operates the menu display button 46 of the second amplifier controller 4-2, the controller 4-2 transmits an operation signal allocated to the menu display button 46 as well as the identification information about the controller to the AV amplifier 2. The control section 21 specifies the second amplifier controller 4-2 as the transmission source of the operation signal based on the identification information. The control section 21 reads image data of the menu from the storage section 22 based on the selector information 2 corresponding to the controller 4-2, and displays the image data on the display device DD2 via the display control section 25.

When the user operates the play stop button of the second amplifier controller 4-2, the controller 4-2 transmits an operation signal allocated to the play stop button as well as the identification information about the controller to the AV amplifier 2. Similarly to the above case, the control section 21 transmits the control signal for stopping the play operation of the output device SD2 from the infrared signal transmitting section 27 to the output device SD2 based on the selector information 2.

When the user operates the channel selecting button 48 of the second amplifier controller 4-2, the controller 4-2 transmits an operation signal allocated to the channel selecting button 48 to the AV amplifier 2. The control section 21 transmits the control signal for switching a channel for a video signal to be input into the display device DD2 from the infrared signal transmitting section 27 to the display device DD2 based on the selector information 2.

As described below, the user operates the first or second amplifier controller 4-1 or 4-2 using the virtual controller 6 so as to control the AV amplifier 2, the output devices SD (for example, SD1, SD2 and SD3), and the common devices CD (for example, DD1, DD2 and GD1).

When the user operates the virtual controller display button 45 of the first amplifier controller 4-1 (S54), the controller 4-1 transmits an operation signal allocated to the virtual controller display button 45 as well as the identification information about the controller to the AV amplifier 2. The control section 21 specifies the first amplifier controller 4-1 as the transmission source of the operation signal based on the identification information, and displays the virtual controller 6 (main panel “menu” MP1) on the output device SD1 via the display control section 25 based on the selector information 1 corresponding to the controller 4-1 (S56).

The control section 21 displays the cursor C for selecting the operation button on the virtual controller 6 on the display device DD1 via the display control section 25. When the user operates the up, down, right and left buttons 43 of the first amplifier controller 4-1 (S58), the controller 4-1 transmits an operation signal allocated to the up, down, right and left buttons 43 as well as the identification information about the controller to the AV amplifier 2.

The control section 21 moves the cursor C according to the operation signal so as to display the moved cursor C on the display device DD1 via the display control section 25 (S60). When the user operates the determination button 44 of the first amplifier controller 4-1 (S62), the control section 21 executes the operation and process corresponding to the operation button selected by the cursor C on the virtual controller 6.

When the user selects the selection tab ST on the virtual controller 6 using the cursor C and operates the determination button 44, the control section 21 prompts the display device DD1 to change the display of the virtual controller 6 via the display control section 25 so that the main panel MP corresponding to the selected selection tab ST is displayed.

When the user operates the operation button, the control section 21 receives an operation signal including the identification information about the device to be controlled from the first amplifier controller 4-1 via the infrared signal receiving section 26 (S64). The control section 21 specifies a device to be controlled based on the identification information about the controller, the identification information about a device to be controlled, and the selector information 1 if necessary (S70). The control section 21 specifies a control signal based on the device to be controlled and the selected operation button (S72), and transmits the specified control signal to the device to be controlled from the infrared signal transmitting section 27 (S74). When a change of the selector information 1 is requested by selecting the input switching button 611 (S66), the control section 21 executes a process according to the selection of the input switching button 611 as descried later (S68).

When the user operates the virtual controller display button 45 (S76), the first amplifier controller 4-1 transmits an operation signal allocated to the virtual controller display button 45 to the AV amplifier 2. The control section 21 switches the display of the virtual controller 6 on the display device DD1 into non-display via the display control section 25 based on the selector information 1 (S78). The process returns to step S52, and the first amplifier controller 4-1 makes control without using the virtual controller 6 (S52).

When the user selects the input switching button 61 on the virtual controller 6, the control section 21 specifies the first amplifier controller 4-1 as the transmission source of the operation signal based on the identification information about the controller so as to make the selector section 24 change the setting of the selector information 1 corresponding to the controller 4-1. Every time when the input switching button 611 is selected, the selector section 24 changes the output device SD as the output source specified by the selector information 1 in the order of the output devices SD1, SD2, SD3, SD1, . . . . The control section 21 displays output videos 1, 2, 3, 1, . . . on the display device DD1 according to the output source specified by the selector information 1.

It is assumed that the user selects the play stop button of the second amplifier controller 4-2 on the main panel “menu” MP1. In this case, the controller 4-2 transmits the operation signal as well as the identification information about the controller and the identification information about the device to be controlled to the AV amplifier 2. Since the main panel “menu” MP1 is selected, the output device SD2 is specified as the identification information about the device to be controlled.

The control section 21 specifies the output device SD 2, which is specified as the output source based on the selector information 2, as the device to be controlled. The control section 21 specifies a control signal for stopping the play operation of the output device SD2 based on the control information about the output device SD2, so as to transmit the control signal from the infrared signal transmitting section 27 to the output device SD2.

It is assumed that, after the user selects the common device selecting (TV) button 631 of the second amplifier controller 4-2 on the main panel “common device” MP3, the user selects the channel selecting button 618. In this case, the controller 4-2 transmits an operation signal as well as the identification information about the controller and the identification information about the device to be controlled to the AV amplifier 2. Since the common device selecting (TV) button 631 is selected, the display device DD2 is specified as the identification information about the device to be controlled.

The control section 21 specifies the display device DD2, which is specified as the output destination based on the selector information 2, as the device to be controlled. The control section 21 specifies a control signal for selecting a channel of the display device DD2 based on the control information about the display device DD2, so as to transmit the control signal from the infrared signal transmitting section 27 to the display device DD2.

As a result, the user can easily control the AV devices 3 including one or more output devices SD (for example, SD1, SD2, SD3) and the plurality of common devices CD (for example, DD1, DD2, GD1) on a plurality of operation areas using the plurality of amplifier controllers 4 (for example, 4-1, 4-2).

In the control system 1 according to the embodiment of the present invention, the operation button is selected through the moving operation of the cursor C on the virtual controller 6. Since a predetermined control signal is transmitted from the AV amplifier 2 to the AV device 3 to be controlled according to the AV device 3 to be controller and the selected operation button, a complicated operation of the amplifier controller 4 is dissolved. Since the virtual controller 6 as well as the output video from the selected output device SD is displayed, an erroneous operation for transmitting operation signals corresponding to the functions of output devices SD other than the selected output device SD is repressed. While a change in an output video is being checked, the operation button is selected on the virtual controller 6.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2008-276823 filed in the Japan Patent Office on 28 Oct. 2008, the entire content of which is hereby incorporated by reference.

What is claimed is:

1. A control apparatus comprising:
a connecting interface which connects a plurality of electronic devices including one or more output devices and one or more display devices;
a selector section which outputs a video signal input from a target output device selected from the one or more output devices to a target display device selected from the one or more display devices;
a display control section which makes the target display device display a virtual controller including a plurality of operation buttons and a cursor for selecting any operation button on the virtual controller as well as an output video to be displayed by the target display device correspondingly to the video signal input from the target output device;
an operation signal receiving section which receives an operation signal for moving the cursor on the virtual controller so as to select an operation button corresponding to a position of the cursor as well as identification information for identifying a device to be controlled selected from the plurality of electronic devices from a controller for the control apparatus; and
a control signal transmitting section which transmits predetermined control signals set to the operation buttons for the respective electronic devices to the device to be controlled according to the device to be controlled and the selected operation button.

2. The control apparatus according to claim 1, further comprising:
a control information setting section which sets the predetermined control signals,
wherein the control information setting section sets a control signal of the electronic device included in the plurality of electronic devices using control information which is preset to the respective electronic devices so that the predetermined control signals are allocated to the plurality of operation buttons on the virtual controller.

3. The control apparatus according to claim 1, further comprising:
a control information setting section which sets the predetermined control signals; and
a control signal receiving section which receives a control signal to be transmitted to the device to be controlled by the control signal transmitting section from the controller of the device to be controlled according to the device to be controlled and a predetermined operation button selected on the virtual controller,
wherein the control information setting section sets the control signal received by the control signal receiving section as the predetermined control signal set to the predetermined operation button for the device to be controlled.

4. The control apparatus according to claim 1, further comprising:
a control information setting section which sets the predetermined control signals, wherein
the control information setting section sets sequence control information including the predetermined control signals including identification information about the electronic devices corresponding to respective operations so that at least the one or more electronic devices are made to perform at least one or more operations sequentially,
the control signal transmitting section transmits the predetermined control signals corresponding to the operations sequentially to the electronic devices corresponding to the operations according to the sequence control information.

5. The control apparatus according to claim 1, further comprising:
first and second controllers for the control apparatus, wherein
the selector section outputs video signals input from first and second target output devices selected from the one or more output devices to first and second target display devices selected from the one or more display devices correspondingly to the first and second controllers for the control apparatus,
the display control section makes the first target display device display a first virtual controller and a first cursor as well as an output video to be displayed by the first target display device correspondingly to the video signal input from the first target output device, and makes the second target display device display a second virtual controller and a second cursor as well as an output video to be displayed by the second target display device correspondingly to the video signal input from the second target output device,
the operation signal receiving section receives from the first controller for the control apparatus a first operation signal for selecting a first operation button on the first virtual controller as well as first identification information for identifying a first device to be controlled selected from the plurality of electronic devices correspondingly to the first controller for the control apparatus, and receives from the second controller for the control apparatus a second operation signal for selecting a second operation button on the second virtual controller as well as second identification information for identifying a second device to be controlled selected from the plurality of electronic devices correspondingly to the second controller for the control apparatus,
the control signal transmitting section transmits predetermined control signals set to the respective operation buttons for the respective electronic devices to the first device to be controlled according to the first device to be controlled and the first selected operation button, and transmits the predetermine control signals to the second device to be controlled according to the second device to be controlled and the selected second operation button.

6. A control system of an electronic device comprising:
one or more output devices;
one or more display devices;
a control apparatus which controls a plurality of electronic devices including the one or more output devices and the one or more display devices; and
a controller for the control apparatus which transmits a predetermined operation signal to the control apparatus, wherein
the control apparatus includes
a connecting interface which connects the plurality of electronic devices including the one or more output devices and the one or more display devices,
a selector section which outputs a video signal input from a target output device selected from the one or more output devices to a target display device selected from the one or more display devices,
a display control section which makes the target display device display a virtual controller including a plurality of operation buttons and a cursor for selecting any operation button on the virtual controller as well as an output video to be displayed by the target display device correspondingly to the video signal input from the target output device,
an operation signal receiving section which receives from the controller for the control apparatus an operation signal for moving the cursor on the virtual controller so as to select an operation button corresponding to a position of the cursor as well as identification information for identifying a device to be controlled selected from the plurality of electronic devices, and
a control signal transmitting section which transmits predetermined control signals set to respective operation buttons for the respective electronic devices to the device to be controlled according to the device to be controlled and the selected operation button.

7. An electronic device control method comprising the acts of:
outputting a video signal input from a target output device selected from one or more output devices to a target display device selected from one or more display devices via a connecting interface for connecting a plurality of electronic devices including the one or more output devices and the one or more display devices;
displaying on the target display device a virtual controller including a plurality of operation buttons and a cursor for selecting any operation button on the virtual controller as well as an output video to be displayed by the target display device correspondingly to the video signal input from the target output device;
receiving from a controller for a control apparatus an operation signal for moving the cursor on the virtual controller so as to select an operation button corresponding to a position of the cursor as well as identification information for identifying a device to be controlled selected from the plurality of electronic devices; and
transmitting predetermined control signals set to respective operation buttons for the respective electronic devices to the target control device according to the device to be controlled and the selected operation button.
